(19) United States
(12) Patent Application Publication
(10) Pub. No.: US 2003/0160502 A1
(43) Pub. Date: Aug. 28, 2003

(54) Wheel-disc wheel

(76) Inventors: Francisco Antonio Magior, Limeira (BR); Paulo Celso De A Sereno, Limeira (BR); Marcelino Marcao, Limeira (BR); Marcio Aparecido De Oliveira, Limeira (BR); Edson Francisco Rofatto, Limeira (BR); Aderval Stein, Limeira (BR); Aparecido Menegazi, Limeira (BR); Miguel Angelo Janieri, Limeira (BR)

Correspondence Address: Smith Gambrell & Russell, Suite 800, 1850 M Street NW, Washington, DC, 20036, US

(21) Appl. No.: 10/069,355

(22) PCT Filed: Jan. 11, 2002
(86) PCT No.: PCT/BR02/00006

(51) Int. Cl. B60B 23/00

(52) U.S. Cl. 301/111.01

(57) ABSTRACT

A wheel (1) is described, particularly for use on vehicles, comprising a disc (3) provided with at least one central region (3′), which has:

at least one bore (7) for fixing the wheel (1) onto a wheel-hub of the vehicle;

at least one association surface (3″) with the wheel-hub; and

at least one central surface (30), substantially opposed to the association surface (3″), the central surface (30) being provided with at least one elevated region (31) having a free end, the length measure between the free end of the elevated region (31) and the association surface (3″) defining a first distance (D),

the bore (7) being located in an elevated portion (4, 5, 6) of the disc (3), a free end (6′) of the elevation portion (4, 5, 6) defining a second distance (D′) as far as the first association surface (3″), the second distance (D′) being substantially longer than the first distance (D1).

The present invention provides a stamped wheel that enables one to fix correctly the same screws used for fixing a light-alloy wheel without the need for spacers, optimizing and rendering cheap its production cost and providing more safety for the user.

The present invention relates to a wheel from a stamped material, particularly useable on vehicles, attachable to the vehicle by means of removable fixation screws.

### DESCRIPTION OF THE PRIOR ART

Two types of wheel are widely known on the automobile market: the stamped ones, usually made of carbon steel, and those manufactures from light metal alloys.

On vehicles equipped with wheels made of light metal alloys, the spare wheel (spare tire) is usually made of stamped steel for economic reasons. So, if they are used on vehicles the wheel hubs of which comprise removable fixation screws, various drawbacks arise.

Due to the different mechanical properties inherent in steel and in light metal alloys, steel wheels and light-alloy wheels have different thickness in its central region. In order to meet quality and resistance standards of use on vehicles and due to the particularities in the manufacturing process, which result directly from the material employed, a wheel manufactured from a light metal alloy is thicker in the central portion than a steel wheel. So, at the moment when it was necessary to use the spare wheel, made of steel and of lesser thickness in the central portion, one found difficulty in fixing it, due to the length of the removable screw, which was suitable for fixing a wheel made of light-metal alloy and became expressive when it was necessary to use the spare wheel.

An apparently immediate alternative would be to increase the thickness of the stamped plate of the wheel, so as to maintain the area of contact with the hub and, at the same time, make the bore compatible with the screws of wheels made of a light-metal alloy. However, this solution would invariably result in new problems, with a higher cost of material and an excessive increase in the weight of the wheel at the moment of using the spare wheel.

In achieve this solution, the new thickness of the wheel would have to be much larger than those that existed before, which would bring difficulties even for its manufacture. In addition to the higher cost, which annuls the advantage of using a steel spare wheel, the substantial increase in the weight of the wheels may impair the stability and steerability of automotive vehicles.

Another solution would be to raise the whole profile of the spare-wheel disc, so as to make the bore of the steel wheel again compatible with the longer screws used with wheels of light-metal alloy. However, this solution is also unfeasible, because it impair the fixation stability of the wheel on the hub, since, in order to maintain the correct fixation, the wheels should have two substantially circular regions of contact between the disc and the hub. If its thickness were maintained, the mere raising of the profile of the wheel would cause this contact to occur in a single region, seriously impairing the wheel-fixation stability.

Both solutions above proposed make it unfeasible for one to take advantages of the technological advances achieved in this branch of the automobile sector.

The developed solution was the adoption of spacers on the spare wheels, fixed in each of the bores for fixing screws, with a view to compensate the difference in thickness between the different wheels. This prevents the screw from touching the bottom of the threaded bore in the wheel hub and, at the same time, provides a correct fixation of the wheel.

However, in spite of solving the existing problems, the utilization of this technique implies a higher production cost, in function of the additional step required for machining and fixing the spacer on the wheel.

### OBJECTIVES OF THE INVENTION

The objective of the present invention is to provide a wheel, especially for use on automotive vehicles, provided with removable fixation screws, the disc of which comprises a structural profile having elevation portions around the regions of fixation of said screws, enabling one to fix the wheel on the vehicle by using longer screws. A second objective is to provide a wheel disc also provided with said elevation portions.

### BRIEF DESCRIPTION OF THE INVENTION

The objectives of the present invention are achieved by means of a wheel, particularly for use on vehicles, comprising a disc provided with at least one central region, which has:

at least one bore for fixing the wheel onto a wheel-hub of the vehicle;

at least one association surface with the wheel-hub; and

at least one central surface, substantially opposed to the association surface, the central surface being provided with at least one elevated region having a free end, the length measure between the free end of the elevated region and the association surface defining a first distance,

the bore being located in an elevation portion of the disc, a free end of the elevation portion defining a second distance as far as the association surface, the second distance being substantially longer than the first distance.

The objectives of the present invention are also achieved by means of a wheel disc for use on a vehicle wheel, comprising a first end portion fixable onto a wheel rim, an association surface associable with a wheel hub of the vehicle and a central surface substantially opposed to the association surface and provided with at least one raised region having a free end, the length measure between the free end of the raised region and the association surface defining a first distance, the disc being characterized by comprising a bore for fixing a wheel, located at a free end of an elevation portion located on the central surface, the length measure between the association surface and the free end configuring a second distance substantially longer than the first distance.

With the wheel of the present invention, the drawbacks of the prior art are eliminated, without the need to change the thickness of the wheel disc and without impairing the fixation stability provided by the steel wheels of the prior art, since a sufficient contact area is preserved between the disc and the hub.

After a long analysis of the material employed and of the forms compatible with the wheels in question, one has come how to stamp the disc of the wheel of the present invention, which provides correct seating of the screws for fixing a light-alloy wheel without the need for spacers, thus optimizing and reducing the production cost, since the production of an additional item (the spacers) is eliminated. In addition, the use of the wheel of the present invention provides greater safety to the user, since the spacers fixed to the wheel eventually get loose, being an unreliable element that has been withdrawn, thus eliminating the risks inherent in the prior art.

Additionally, the partial elevation of the profile around the fixation bore brings about an aesthetic improvement to the wheel of the prior art, since it eliminates the visible spacers, which are esthetically discordant.

### BRIEF DESCRIPTION OF THE DRAWINGS

The present invention will now be described in greater detail with reference to an embodiment represented in the drawings. The figures show:

FIG. 1 is a perspective view of the stamped wheel provided with spacers of the prior art;

FIG. 2 is a detailed view of the wheel illustrated in FIG. 1;

FIG. 3 is a perspective view in detail of a part of the wheel of the present invention; and

FIG. 4 is a longitudinal section schematic view of the wheel of the present invention.

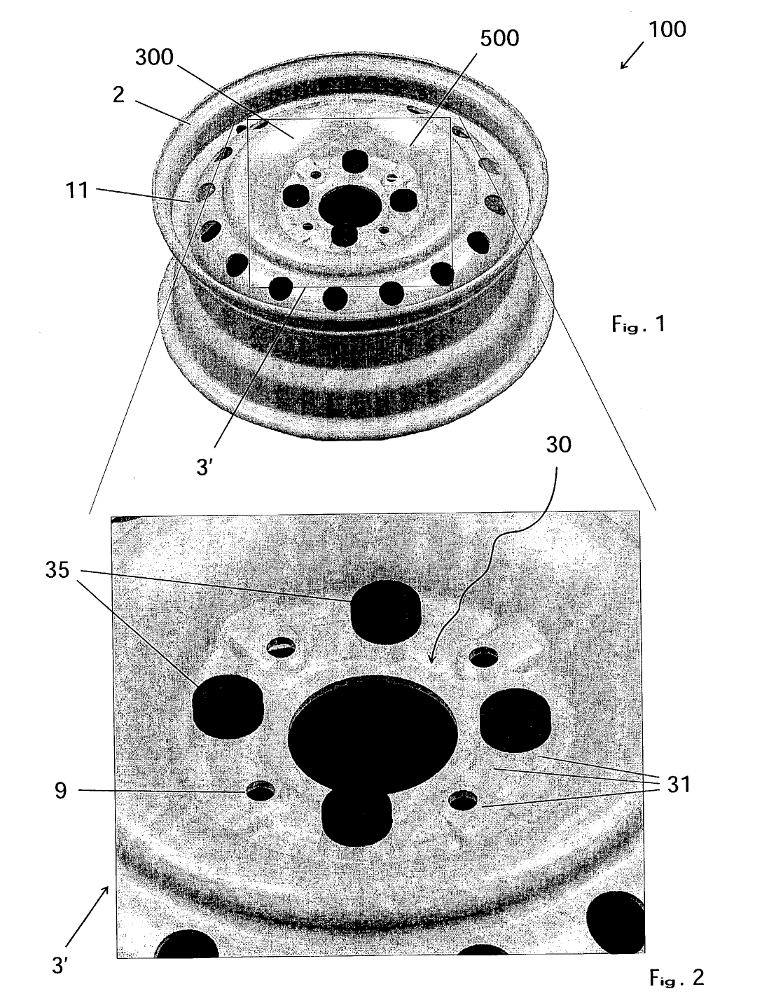

### DETAILED DESCRIPTION OF THE FIGURES

Stamped-steel wheels usually comprise a rim 2 and a disc 3,300 made of stamped carbon steel, joined to each other preferably by means of welding, the disc 3,300 comprising a first end portion 11 fixable to the rim 2.

The rim 2 has a substantially cylindrical shape and its wall has a cross-section with a shape in which the ends are facing outwards in the direction of the external side of the wheel 1,100, configuring a protrusion, also called “Hump”, thus enabling one to place the tire (not shown) correctly. The disc 3,300 optionally has a plurality of vent windows for cooling the brake system of the vehicle, which still functions with esthetic elements, and the center has a bore substantially concentric with the longitudinal axis of the disc 3,300, in order to create a space for the tip of the vehicle axle, which is protuberant when the wheel is mounted thereon. The wheels 100 of the prior art have spacing elements 35, fixed to the bores for inserting the wheel screws. The spacers are used to enable one to mount the wheel with screws designed for mounting light-allow wheels, which are longer.

The disc 3,300, the shape of which is substantially that of a circular plate with relief portions, has a central region 3′, which comprises said concentric bore and at least one or a plurality of bores 7 for fixing the wheel 1. The disc 3,300 still comprises at least one, but preferably a plurality of elevated regions 31 in the form of structural or esthetic protuberances, which compose the appearance of the central region 3′. In the preferred embodiment, the wheel has as many bores 7 as are necessary. In the region outside the central region, the disc 3 has a large elevation 500.

This central region 3′ defines a first central association surface 3″, which contacts the wheel-hub when the wheel 1,100 is mounted to the vehicle. Thus, this first surface 3″ defines the internal side of the wheel 1,100 the side that touches the wheel hub.

The central region 3″ also defines a second central surface 30, located substantially opposed to the first surface 3″, which is the external surface of the wheel. The referred-to optional protuberances are located on this second central surface 30.

The length measure between the ends of the elevated regions 31 and the first surface 3″ is considered a first distance D and is equivalent to the sum of the thickness of the central region 3′ of the disc 3 plus the height of the protuberances, when they exist. However, when the wheel 1,100 does not have the elevated regions 31, the first distance D is the thickness measure of the central region 3′ of the disc 3.

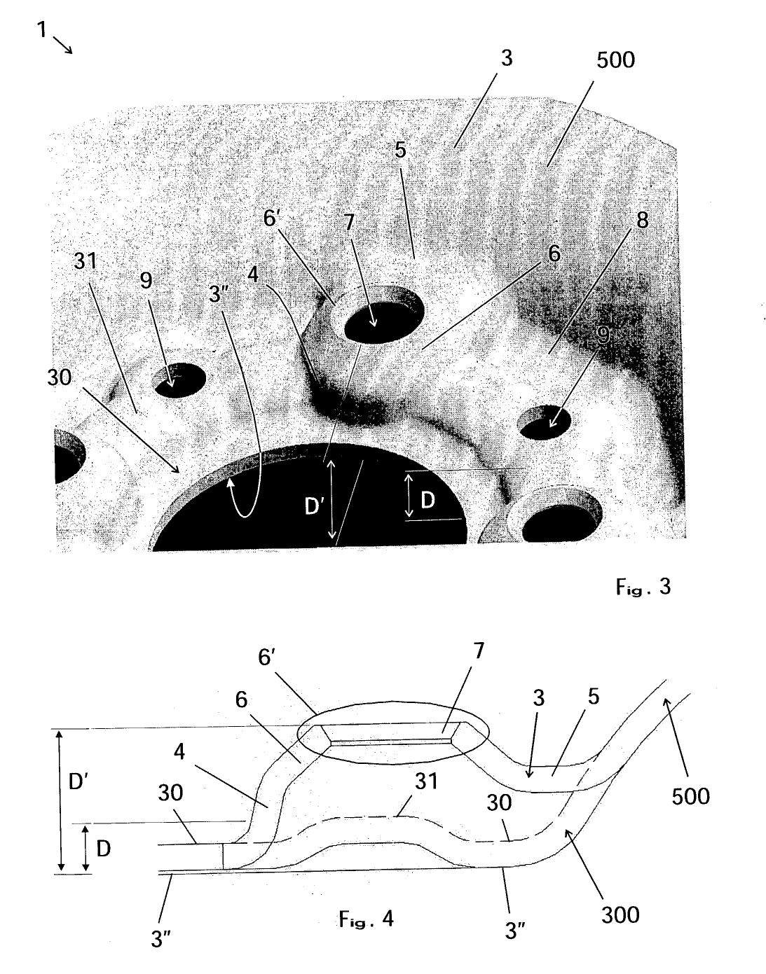

According to a preferred embodiment and as can be seen from FIG. 3, the wheel 1 of the present invention still comprises four elevation portions 4, 5, 6, in which are located the four bores 7 for fixing the wheel 1, the elevation portions being substantially orthogonal to the second central surface 30. The elevation portions are substantially conical in shape and have a free end 6′, which presents the bore 7. In this bore, there is a conical surface to facilitate the final tightening of the screw (which is not shown).

Each elevation portion comprises a first region 4, which is substantially orthogonal to and prolongs from the second central surface 30, which is substantially semicylindrical and concentric to the bore 7.

From this first region 4, there is a second region 6, substantially conical, annular and concentric to the first region 4, the second region 6 projecting substantially angularly from the first region 4 to the free end 6′.

The elevation portions 4, 5, 6 further comprise a third region 5 substantially adjacent to the free end 6′ and parallel to the second central surface 30. This third region 5 is also linked to the elevation 500 or to a region adjacent thereto, so as to be located between the free end 6′ and the elevation 500.

The length measure between the free end 6′ of the elevation portion 4, 5, 6 and the first association surface 3″ defines a second distance D′, which is substantially longer than said first distance D, since said projection extends from the second central surface 30. In this way, one can use longer screws than those suitable for fixing an ordinary wheel, without spacers, the difference between the distance D′ and the distance D compensates the screw size. As already mentioned, the longer screws are sued with light-metal-alloy wheels.

In order to mount the wheel 1 onto the wheel-hub correctly, four contact regions 8 are provided, which are included in the second central surface 30 and complement the contact region adjacent the alreadydescribed concentric bore. The number of contact regions 8 may vary, depending on the number of fixation bores 7 and of optional protuberances, provided that the mounting of the wheel is not impaired.

Optionally, there may be bores for guide pins for placing the wheel 9, as can be seen in the figures.

The wheel 1 of the present invention may be stamped on any material that enables one to manufacture it.

A preferred embodiment having been described, it should be understood that the scope of the present invention embraces other possible variations, being limited only by the contents of the accompanying claims, which include the possible equivalents.

1. A wheel (1), particularly for use on vehicles, comprising a disc (3) provided with at least one central region (3′), which has:
at least one bore (7) for fixing the wheel (1) onto a wheel-hub of the vehicle;
at least one association surface (3″) with the wheel-hub; and
at least one central surface (30), substantially opposed to the association surface (3″), the central surface (30) being provided with at least one elevated region (31) having a free end, the length measure between the free end of the elevated region (31) and the association surface (3″) defining a first distance (D),
the wheel (1) being characterized in that the bore (7) is located in an elevation portion (4, 5, 6) of the disc (3), a free end (6′) of the elevation portion (4, 5, 6) defining a second distance (D′) as far as the association surface (3″), the second distance (D′) being substantially longer than the first distance (D).

2. A wheel according to claim 1, characterized by comprising a plurality of fixation bores (7).

3. A wheel according to claim 1 or 2, characterized in that the central region (3′) comprises at least one substantially plane region (8), cir cumferentially arranged and adjacent to the elevation portion (5).

4. A wheel according to claim 1, characterized in that the elevation portion (4, 5, 6) comprises a first region (4) substantially orthogonal to the central surface (30), the first region (4) being substantially semicylindrical and concentric to the bore (7) and prolonging from said central surface (30).

5. A wheel according to claim 1, characterized in that the elevation portion (4, 5, 6) comprises a second region (6) substantially conical and concentric to the first region (4), the second region (6) projecting substantially angular from the first region (4) as far as the free end (6′).

6. A wheel according to claim 1, characterized in that the elevation portion (4, 5, 6) comprises a third region (5) adjacent to the free end (6′) and substantially parallel to the central surface (30).

7. A wheel according to claim 1, characterized in that it is fixed onto the wheel-hub by means of removable screws.

8. A wheel-disc (3) for use on a vehicle wheel, comprising a first end portion (11) fixable to a wheel-rim (2), an association surface (3″) associable with a wheel-hub and a central surface (30), substantially opposed to the association surface (3″) and provided with at least one elevated region (31) having a free end, the length measure between the free end of the elevated region (31) and the association surface (3″) defining a first distance (D), the disc (3) being characterized by comprising a bore (7) for fixing the wheel located at one free end (6′) of an elevation portion located on the central surface (30), the length measure between the association surface (3″) and the free end (6′) configuring a second distance (D′) substantially longer than the first distance (D).

9. A disc according to claim 8, characterized by being substantially circular in shape.
